(19) United States
(12) Patent Application Publication
(10) Pub. No.: US 2009/0042093 A1
(43) Pub. Date: Feb. 12, 2009

(54) PROTON CONDUCTOR FOR FUEL CELL AND FUEL CELL INCLUDING THE SAME

(75) Inventors: Jung-ock PARK, Yongin-si (KR); Duck-young YOO, Seoul (KR)

Correspondence Address: STEIN, MCEWEN & BUI, LLP, 1400 EYE STREET, NW, SUITE 300, WASHINGTON, DC, 20005, US

(73) Assignees: Samsung Electronics Co., Ltd., Suwon-si (KR); Samsung SDI Co., Ltd., Suwon-si (KR)

(21) Appl. No.: 12/034,067

(22) Filed: Feb. 20, 2008

(30) Foreign Application Priority Data
Aug. 6, 2007 (KR) 2007-78671

(51) Int. Cl. H01M 4/90; H01M 8/02

(52) U.S. Cl. 429/42; 429/12; 429/44

(57) ABSTRACT

Provided are a proton conductor for a fuel cell, the proton conductor including a phosphoric acid-based material; and a C8-C20 perfluoroalkylsulfonic acid salt which is dissolved in the phosphoric acid-based material and has excellent oxygen solubility characteristics, an electrode including the proton conductor, an electrolyte membrane for a fuel cell including the proton conductor, and a fuel cell including the electrode and the electrolyte membrane. When the C8-C20 perfluoroalkylsulfonic acid salt is used in the preparation of the electrode and electrolyte membrane for a fuel cell, oxygen solubility is increased in a phosphoric acid-based material and oxygen concentration is increased in a phosphoric acid-based material of the electrode. Thus, reactivity of oxygen reduction which is performed in a cathode is increased. Increased concentration of oxygen in the electrode increases oxygen permeability in the cathode, and thus the resistance against reactants' transfer is decreased. As a result, the cell voltages can be increased using the electrode and the electrolyte membrane, and fuel cells having improved efficiency can be prepared.

### CROSS-REFERENCE TO RELATED APPLICATION

This application claims the benefit of Korean Patent Application No. 10-2007-0078671, filed on Aug. 6, 2007, in the Korean Intellectual Property Office, the disclosure of which is incorporated herein in its entirety by reference.

### BACKGROUND OF THE INVENTION

1. Field of the Invention

The present invention relates to a proton conductor for a fuel cell and a fuel cell including the same, and more particularly, to a proton conductor for a fuel cell capable of increasing oxygen permeability in an electrode due to excellent oxygen solubility characteristics and a fuel cell having an electrode and an electrolyte membrane including the proton conductor.

2. Description of the Related Art

Polymer electrolyte membrane fuel cells (PEMFCs), a type of fuel cells using phosphoric acid as an electrolyte, operate at 80° C. and Nafion is used as a binder and proton conductor in an electrode.

If the temperature is increased from 80° C. to 130° C. or higher, the PEMFCs simply operate without a humidifier, and a catalyst is less poisoned by CO.

However, when the temperature is higher than 130° C., the Nafion cannot be used any longer. Thus, a novel material functioning as the binder and proton conductor needs to be employed to substitute the Nafion.

Phosphoric acid is currently used as an electrolyte and a proton conductor in an electrode of PEMFCs which operate at a temperature of 100° C. of higher.

Although the phosphoric acid is stable at a temperature up to 200° C. and has excellent proton conductivity, it has a low oxygen reduction rate. The oxygen reduction rate is low in the phosphoric acid since the phosphoric acid is adsorbed on the catalyst and has low oxygen solubility.

Thus, an overvoltage is applied to a cathode due to the low oxygen reduction rate of the phosphoric acid.

Although a proton conductive medium using fluoroborate or fluoroheteroborate has been disclosed in Korean Patent Publication No. 2006-49069, there is still a need to improve the efficiency of fuel cells since the proton conductive medium does not sufficiently improve efficiency of the fuel cells.

### SUMMARY OF THE INVENTION

The present invention provides a proton conductor for a fuel cell, the proton conductor including an additive which can increase reduction rates of oxygen in a cathode, an electrode, and an electrolyte membrane, and a fuel cell including the proton conductor.

According to an aspect of the present invention, there is provided a proton conductor for a fuel cell, comprising:

a phosphoric acid-based material; and

a C8-C20 perfluoroalkylsulfonic acid salt which is dissolved in the phosphoric acid-based material and has good oxygen solubility.

According to another aspect of the present invention, there is provided an electrolyte membrane for a fuel cell, comprising:

a proton conductor including a phosphoric acid-based material and a C8-C20 perfluoroalkylsulfonic acid salt which is dissolved in the phosphoric acid-based material and has good oxygen solubility; and

a proton conductive polymer.

According to another aspect of the present invention, there is provided a fuel cell comprising a pair of electrodes and an electrolyte membrane interposed between the electrodes,

wherein at least one of the electrodes and the electrolyte membrane comprises a proton conductor which includes: a phosphoric acid-based material; and a C8-C20 perfluoroalkylsulfonic acid salt which is dissolved in the phosphoric acid-based material and has good oxygen solubility.

### BRIEF DESCRIPTION OF THE DRAWINGS

The above and other features and advantages of the present invention will become more apparent by describing in detail exemplary embodiments thereof with reference to the attached drawings in which:

FIG. 1 shows a perspective view of a fuel cell according to an embodiment of the present invention;

FIG. 2 schematically shows a cross-sectional view of a membrane-electrode assembly in the fuel cell of FIG. 1;

FIGS. 3 and 5 are graphs illustrating results of oxygen concentration analyses according to Evaluation Example 1 of the present invention; and

FIG. 4 is a graph illustrating potentials according to current densities of fuel cells according to Examples 1 and 2 and Comparative Example 1.

### DETAILED DESCRIPTION OF THE INVENTION

Hereinafter, the present invention will now be described more fully with reference to the accompanying drawings, in which exemplary embodiments of the invention are shown.

The present invention provides a proton conductor for a fuel cell, including: a phosphoric acid-based material; and an additive which is dissolved in the phosphoric acid-based material and increases oxygen solubility of the phosphoric acid-based material to increase the amount of oxygen, as a reactant, which is supplied to a catalyst of a cathode.

The additive may be a C8-C20 perfluoroalkylsulfonic acid salt which increases oxygen solubility when dissolved in a phosphoric acid-based material such as phosphoric acid and is stable at a high temperature, particularly in a temperature range of 130 to 200° C.

Examples of the C8-C20 perfluoroalkylsulfonic acid salt are perfluorooctanesulfonic acid potassium (CF₃(CF₂)₇SO₃K) and perfluorodecanesulfonic acid potassium (CF₃(CF₂)₉SO₃K).

The amount of the C8-C20 perfluoroalkylsulfonic acid salt may be from 0.005 to 0.5 parts by weight, and preferably 0.05 to 0.1 parts by weight, based on 100 parts by weight of the proton conductor, that is, the total weight of the phosphoric acid-based material and the C8-C20 perfluoroalkylsulfonic acid salt.

When the amount of the C8-C20 perfluoroalkylsulfonic acid salt is less than 0.005 parts by weight, the increase in oxygen solubility of the phosphoric acid is negligible. On the other hand, when the amount of the C8-C20 perfluoroalkylsulfonic acid salt is greater than 0.5 parts by weight, the resistance of cells may be increased.

The phosphoric acid-based material used in the present invention may be phosphoric acid or C1-C20 organic phosphonic acid.

Examples of the phosphoric acid are metaphosphoric acid, orthophosphoric acid, paraphosphoric acid, triphosphoric acid and tetraphosphoric acid, and preferably orthophosphoric acid. Examples of the C1-C20 organic phosphonic acid are a C1-C10 alkylphosphonic acid such as methylphosphonic acid, ethylphosphonic acid and propylphosphonic acid, vinylphosphonic acid, phenylphosphonic acid, or the like.

When the phosphoric acid or organic phosphonic acid is used in an aqueous solution, the concentration of the aqueous solution of the phosphoric acid or the organic phosphonic acid may be in the range of 20 to 100% by weight, and preferably in the range of 85 to 100% by weight.

The proton conductor may be used in the preparation of an electrode and/or an electrolyte membrane.

First, an electrode for a fuel cell, the electrode including the proton conductor, and a method of preparing the electrode will be described in detail.

An electrode for a fuel cell according to the present invention includes a catalyst layer having: the proton conductor; a catalyst; and a binder. In a fuel cell system using the electrode as a cathode, when air flows to a cathode, oxygen is dissolved in phosphoric acid and reduced in the catalyst in the electrode. When the concentration of oxygen is increased in the phosphoric acid, an oxygen reaction is accelerated and thus cell performance is improved.

The catalyst may be at least one of Pt and Pt-based alloys such as PtCo, PtRu, PtFe and PtNi. The catalyst may also be a supported catalyst in which at least one of the catalyst metals is loaded on a carbonaceous support. Carbon black may be used as the carbonaceous support, and the amount of the catalyst metal may be in the range of 10 to 70 parts by weight based on 100 parts by weight of the supported catalyst, that is, the total amount of the catalyst metal and the support.

The binder can be any material that can provide the catalyst layer of the electrode with binding force toward a current collector. Examples of the binder are poly(vinylidene fluoride), polytetrafluoroethylene (PTFE), a tetrafluoroethylene-hexafuoroethylene copolymer, fluorinated ethylene propylene (FEP), polyurethane and styrene butadiene rubber (SBR), but are not limited thereto. The amount of the binder may be in the range of 0.001 to 0.5 parts by weight based on 1 part by weight of the catalyst. When the amount of the binder is less than 0.001 parts by weight, a wet state of the electrode is not sufficiently improved. On the other hand, when the amount of the binder is greater than 0.5 parts by weight, resistance is increased in the electrode, and thus cell performance may be decreased.

In addition, the amount of the proton conductor may be in the range of 0.01 to 20 parts by weight based on 1 part by weight of the catalyst. When the amount of the proton conductor is less than 0.01 parts by weight, cell performance may be decreased due to insufficient conductivity in the electrode. On the other hand, when the amount of the proton conductor is greater than 20 parts by weight, flooding may occur in the catalyst layer due to excess amount of the phosphoric acid.

A process of preparing an electrode for a fuel cell according to the present invention will be described.

First, a composition for an electrode catalyst layer is prepared by mixing a catalyst, a binder and a solvent.

The solvent may be N-methylpyrrolidone (NMP), dimethylacetamide (DMAC), or the like, and the amount of the solvent may be in the range of 1 to 10 parts by weight based on 1 part by weight of the catalyst.

The composition for an electrode catalyst layer is coated on the surface of a carbon support to prepare an electrode. The carbon support may be fixed on a glass substrate to facilitate coating. The coating may be performed using a doctor blade coating method, a bar coating method, a screen printing method, or the like, but the coating method is not limited thereto.

The coated composition for an electrode catalyst is dried to evaporate the solvent at a temperature in the range of 20 to 150° C. The composition may be dried for 10 to 60 minutes, but the drying time may vary according to the drying temperature.

The electrode is impregnated in a mixture of a phosphoric acid-based material and a C8-C20 perfluoroalkylsulfonic acid salt to prepare an electrode according to the present invention.

As desired, the phosphoric acid-based material and the C8-C20 perfluoroalkylsulfonic acid salt can be added to the composition for an electrode catalyst layer to prepare an electrode.

The electrode for a fuel cell according to the present invention is efficiently used in a high temperature PEMFC or PAFC.

Hereinafter, an electrolyte membrane according to the present invention will be described in detail.

An electrolyte membrane according to the present invention includes a proton conductor and a proton conductive polymer.

In the electrolyte membrane, the amount of the phosphoric acid-based material may be in the range of 100 to 2000 parts by weight based on 100 parts by weight of the proton conductive polymer.

The amount of the C8-C20 perfluoroalkylsulfonic acid salt is in the range of 0.005 to 0.5 parts by weight based on 100 parts by weight of the proton conductor and in the range of 0.005 to 10 parts by weight based on 100 parts by weight of the proton conductive polymer.

When the amount of the C8-C20 perfluoroalkylsulfonic acid salt is less than the range described above, the effect to reduction of oxygen in the cathode of the C8-C20 perfluoroalkylsulfonic acid salt is negligible. On the other hand, when the amount of the C8-C20 perfluoroalkylsulfonic acid salt is greater than the range described above, conductivity of the phosphoric acid-based proton conductor may be decreased.

The proton conductive polymer used in the formation of the electrolyte membrane may be polybenzimidazole, a crosslinked product of polybenzoxazine-based compounds, a polybenzoxazine-polybenzimidazole copolymer, or the like.

The crosslinked product of polybenzoxazine-based compounds is disclosed in Korean Patent Application Nos. 2006-11831 and 2006-48303. Particularly, the crosslinked product of polybenzoxazine-based compound may be prepared by polymerizing a first benzoxazine-based monomer represented by Formula 1 below and a second benzoxazine-based monomer represented by Formula 2 represented by Formula 2 below using a crosslinking agent.

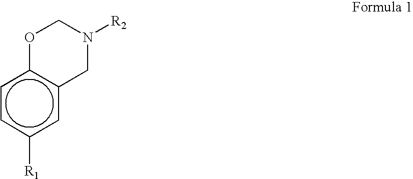

where, R₁ is a hydrogen atom, a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C2-C20 heteroaryl group, a substituted or unsubstituted C4-C20 cycloalkyl group or a substituted or unsubstituted C2-C20 heterocyclic group, a halogen atom, a hydroxy group, or a cyano group,

R₂ is a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C7-C20 arylalkyl group, a substituted or unsubstituted C2-C20 heteroaryl group, a substituted or unsubstituted C3-C20 heteroarylalkyl group, a substituted or unsubstituted C4-C20 a carbocyclic group, a substituted or unsubstituted C5-C20 carbocyclic alkyl group, a substituted or unsubstituted C2-C20 heterocyclic group, or a substituted or unsubstituted C3-C20 heterocyclic alkyl group.

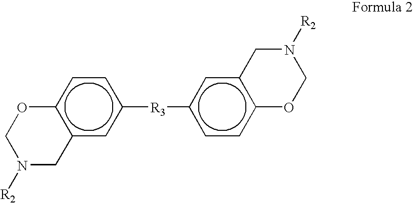

where, R₂ is a substituted or unsubstituted C1-C20 alkyl group, a substituted or unsubstituted C2-C20 alkenyl group, a substituted or unsubstituted C2-C20 alkynyl group, a substituted or unsubstituted C6-C20 aryl group, a substituted or unsubstituted C7-C20 arylalkyl group, a substituted or unsubstituted C2-C20 heteroaryl group, a substituted or unsubstituted C3-C20 heteroarylalkyl group, a substituted or unsubstituted C4-C20 carbocyclic group, a substituted or unsubstituted C5-C20 carbocyclic alkyl group, a substituted or unsubstituted C2-C20 heterocyclic group, or a substituted or unsubstituted C3-C20 heterocyclic alkyl group,

R₃ is a substituted or unsubstituted C1-C20 alkylene group, a substituted or unsubstituted C2-C20 alkenylene group, a substituted or unsubstituted C2-C20 alkynylene group, a substituted or unsubstituted C6-C20 arylene group, a substituted or unsubstituted C2-C20 heteroarylene group, —C(═O)—, or —SO₂—.

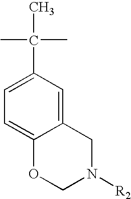

where, R₂ is described above with reference to Formula 1.

The amount of the second benzoxazine-based monomer may be in the range of 0.5 to 50 parts by weight, and preferably 1 to 10 parts by weight, based on 100 parts by weight of the first benzoxazine-based monomer.

A crosslinking agent used in an embodiment of the present invention can be any compound capable of crosslinking with benzoxazine-based monomers.

The crosslinking agent may include at least one of polybenzimidazole (PBI), polybenzthiazole, polybenzoxazole, and polyimide, but is not limited thereto. The amount of the crosslinkable compound may be in the range of 5 to 95 parts by weight based on 100 parts by weight of the first benzoxazine-based monomer and the second benzoxazine-based monomer.

The crosslinked polybenzoxazine-based compound according to an embodiment of the present invention can be prepared by crosslinking a first benzoxazine-based monomer represented by Formula 3 and a second benzoxazine-based monomer represented by Formula 4 with PBI.

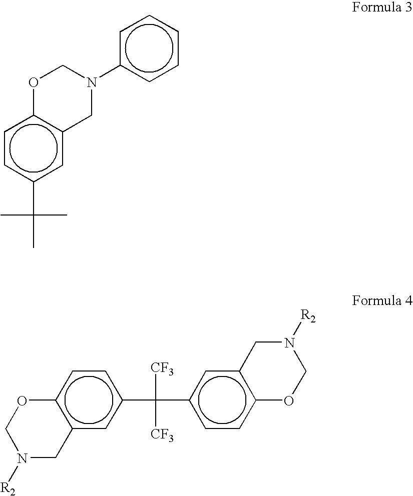

where, R₂ is a phenyl group.

The electrolyte membrane is prepared by impregnating an electrolyte membrane formed using the materials described above in a proton conductor including a phosphoric acid-based material and a C8-C20 perfluoroalkylsulfonic acid salt.

In the preparation of the electrode as described above, the C8-C20 perfluoroalkylsulfonic acid salt can be added to the composition for an electrode catalyst layer, but the preparation method is not limited thereto.

For example, an electrode and an electrolyte membrane are prepared according to conventional methods, and the electrolyte membrane is impregnated in a proton conductor including a phosphoric acid-based material and a C8-C20 perfluoroalkylsulfonic acid salt. Then, a membrane and electrode assembly (MEA) is prepared using the electrolyte membrane and the electrode.

A fuel cell is prepared using the MEA. In the fuel cell, the proton conductor including the phosphoric acid-based material and the C8-C20 perfluoroalkylsulfonic acid salt which is impregnated in the electrolyte membrane is transferred to the electrode. Alternatively, an electrode is formed by a conventional method and the electrode is impregnated in the proton conductor including the phosphoric acid-based material and the C8-C20 perfluoroalkylsulfonic acid salt.

Hereinafter, a fuel cell according to an embodiment of the invention will be described in detail.

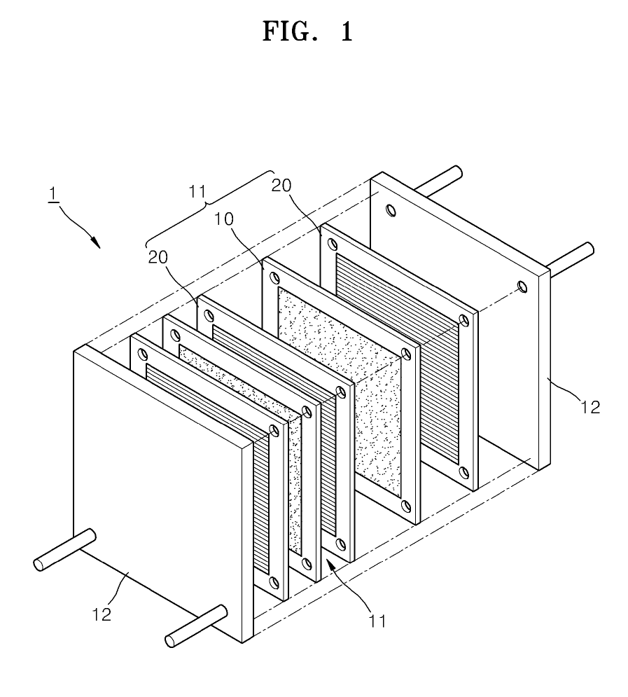

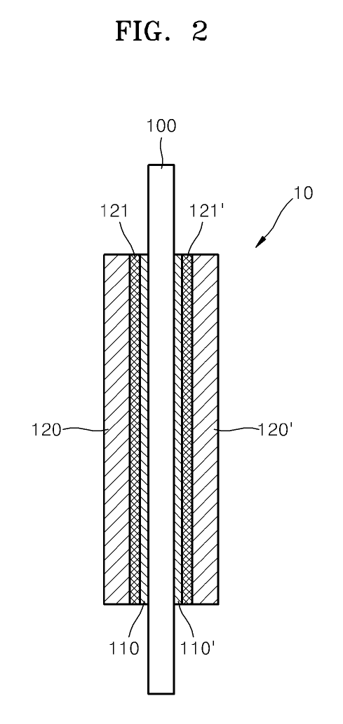

FIG. 1 shows a perspective view of a fuel cell according to an embodiment of the present invention, and FIG. 2 schematically shows a cross-sectional view of a membrane-electrode assembly included in the fuel cell of FIG. 1.

Referring to FIG. 1, a fuel cell 1 includes two unit cells 11 which are supported by a pair of holders 12. Each unit cell 11 includes a membrane-electrode assembly 10 and bipolar plates 20 which are respectively disposed on both side of the membrane-electrode assembly. The bipolar plates 20 are formed of a conductive material such as a metal or carbon, and are respectively assembled with the membrane-electrode assembly 10. Thus, the bipolar plates 20 function as current collectors and supply oxygen and fuel to a catalyst layer of the membrane-electrode assembly 10.

In addition, the fuel cell 1 shown in FIG. 1 has two unit cells 11, but the number of the unit cells 11 is not limited and may be up to several hundreds according to the characteristics required for the fuel cell 1.

The membrane-electrode assembly 10 includes a polymer electrolyte membrane for a fuel cell (hereinafter, electrolyte membrane) 100, catalyst layers 110 and 110′ disposed on either side of the electrolyte membrane 100, first gas diffusion layers 121 and 121′ respectively formed on the catalyst layers 110 and 110′, and second gas diffusion layers 120 and 120′ respectively formed on the first gas diffusion layers 121 and 121′ as shown in FIG. 2.

Each of the catalyst layers 110 and 110′ which function as a fuel electrode and an oxygen electrode includes: a proton conductor for a fuel cell including a phosphoric acid-based material and a C8-C20 perfluoroalkylsulfonic acid salt which is dissolved in the phosphoric acid-based material and has good oxygen solubility; a catalyst; and a binder.

The first gas diffusion layers 121 and 121′ and the second gas diffusion layers 120 and 120′ are formed of, for example, carbon sheet or carbon paper and diffuse oxygen and fuel supplied through the bipolar plates 20 throughout the catalyst layers 110 and 110′.

The fuel cell 1 including the membrane-electrode assembly 10 operates at a temperature in the range of 100 to 300° C. A fuel, for example, hydrogen, is supplied to a first catalyst layer through the bipolar plate 20, and an oxidizer, for example, oxygen, is supplied to a second catalyst layer through the bipolar plate 20. Then, hydrogen is oxidized to protons in the first catalyst layer, an electrolyte membrane 4 conducts the protons to the second catalyst layer, and the conducted protons electrochemically react with oxygen in the second catalyst layer to form water and generate electric energy.

In addition, hydrogen supplied as a fuel may be generated by modification of hydrocarbon or alcohol, and oxygen supplied as an oxidizer may be supplied with air.

Subsequently, the electrolyte membrane 100 included in the membrane-electrode assembly 1 will be described.

The electrolyte membrane 100 according to the present invention may include: a proton conductor having a phosphoric acid-based material and a C8-C20 perfluoroalkylsulfonic acid salt which is dissolved in the phosphoric acid-based material and has excellent oxygen solubility; and a proton conductive polymer.

In addition, any electrolyte membrane that is commonly used for a fuel cell can be used as the electrolyte membrane 100. Examples of the electrolyte membrane 100 are polybenzimidazole electrolyte membrane, polybenzoxazine-polybenzimidazole copolymer electrolyte membrane, polytetrafluoroethylene (PTFE) electrolyte membrane, and crosslinked polybenzoxazine-based compound.

The present invention will now be described in greater detail with reference to the following examples. The following examples are for illustrative purposes only and are not intended to limit the scope of the present invention.

### EVALUATION EXAMPLE 1

### Measurement of Oxygen Concentration in Phosphoric Acid

The concentration of oxygen was measured in 85 wt % of H₃PO₄ solution in water using a rotating disk electrode. Here, 100 parts by weight of 85 wt % H₃PO₄ solution in water; a mixture of 99.995 parts by weight of 85 wt % H₃PO₄ and 0.005 parts by weight of perfluorooctanesulfonic acid potassium; a mixture of 99.95 parts by weight of 85 wt % H₃PO₄ solution in water and 0.05 parts by weight of perfluorooctanesulfonic acid potassium, and a mixture of 99.5 parts by weight of 85 wt % H₃PO₄ solution in water and 0.5 parts by weight of perfluorooctanesulfonic acid potassium were used as test samples. Here, the mixtures of 85 wt % H₃PO₄ solution in water and perfluorooctanesulfonic acid potassium were prepared by mixing the 85 wt % H₃PO₄ solution in water and perfluorooctanesulfonic acid potassium at 80° C. for 3 hours.

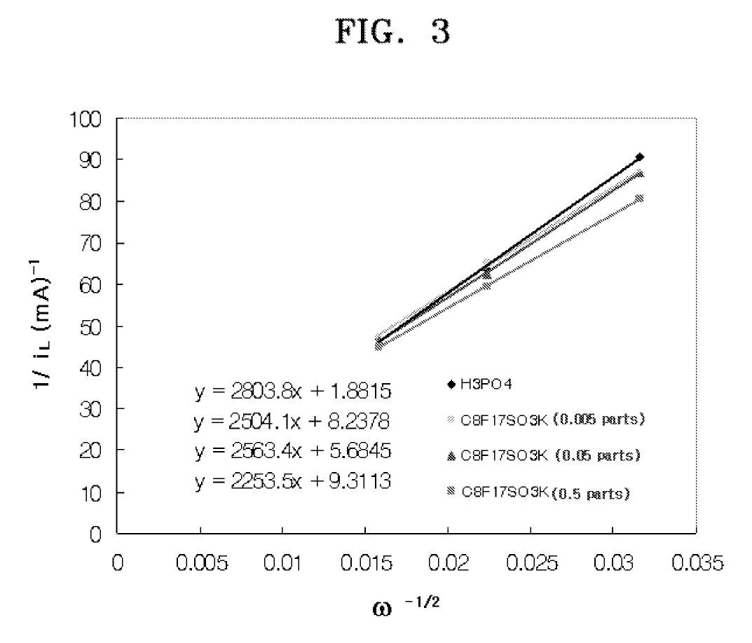

According to Equation 1 below, a current (i_{L}) was measured at room temperature (25° C.) while a rotating rate of the electrode (ω) was varied, and inclination was obtained by modifying 1/i and i/ω^{-1/2}. The results are shown in FIG. 3. The inclination is a function of 1/C, and C is a concentration of oxygen. Thus, the concentration of oxygen increases as the inclination shown in FIG. 3 decreases.

1/i=1/iₖ+1/(0.62 n F A D^{2/3}ω^{1/2}v^{-1/6}C)

where, n, F, A, D and v are constants, and n is the number of electrons participating the reaction, F is the Faraday constant, A is a surface area of the electrode, D is a diffusion coefficient of reactant, v is a kinematic viscosity of the electrolyte, C is a concentration of oxygen, and iₖ is a current of oxygen reduction.

The test results are shown in FIG. 3.

Referring to FIG. 3, the concentration of oxygen increased in the phosphoric acid as the inclination decreased. According to the results of FIG. 3, the concentration of oxygen was maximized when the amount of the perfluorooctanesulfonic acid potassium was maximized. That is, when the amount of the perfluorooctanesulfonic acid potassium was 0.5 parts by weight, the concentration of oxygen was maximized. In addition, the concentration of oxygen when the amount of the perfluorooctane sulfonic acid potassium was 0.5 parts by weight was increased by 1.24 times compared to the concentration of oxygen when only phosphoric acid was used. When the concentration of oxygen increased, the oxygen reduction was accelerated and thus cell voltage increased.

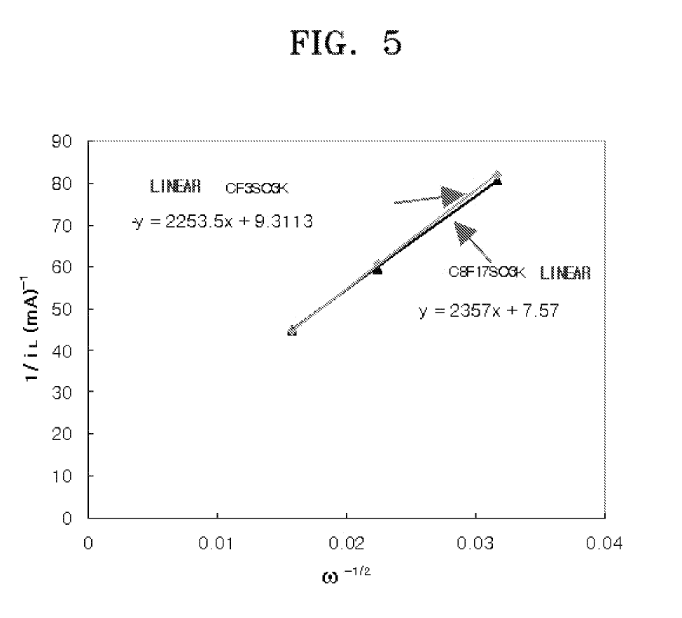

Meanwhile, a mixture of 99.5 parts by weight of 85 wt % H₃PO₄ solution in water and 0.5 parts by weight perfluorooctanesulfonic acid potassium and a mixture of 99.5 parts by weight of 85 wt % H₃PO₄ solution in water and 0.5 parts by weight of CF₃SO₃K were used as test samples. According to Equation 1, a current (j) was measured at room temperature (25° C.) while a rotating rate of the electrode (ω) was varied, and inclination was obtained by floating 1/i and i/ω^{-1/2}. The results are shown in FIG. 5.

Referring to FIG. 5, upon comparing inclinations of 1/i and ω, it can be seen that perfluorooctanesulfonic acid potassium increases the oxygen solubility in phosphoric acid compared to trifluoromethansulfonic acid potassium (CF₃SO₃K).

### SYNTHESIS EXAMPLE 1

### Preparation of Benzoxazine-Based Monomer (BOA) Represented by Formula 3

1 mol of tertiary butylphenol, 2.2 mol of p-formaldehyde, and 1.1 mol aniline were mixed and stirred without a solvent at 100° C. for 1 hour to produce a crude product.

The crude product was washed twice with 1N NaOH aqueous solution and once with distilled water, and dried with magnesium sulfate. Then, the resultant was filtered, and the solvent was removed. The resultant was dried in a vacuum to obtain benzoxazine-based monomer represented by Formula 3 (Yield: 95%).

### SYNTHESIS EXAMPLE 2

### Preparation of Benzoxazine-Based Monomer Represented by Formula 4 (HFA) (R₂=Phenyl Group)

1 mol of 4,4′-hexafluoroisopropylidene diphenol (4,4′-HFIDPH), 4.4 mol of p-formaldehyde, and 2.2 mol benzene were mixed and stirred without a solvent at 100° C. for 1 hour to produce a crude product.

The crude product was washed twice with 1N NaOH aqueous solution and once with distilled water, and dried with magnesium sulfate. Then, the resultant was filtered, and the solvent was removed. The resultant was dried in a vacuum to obtain benzoxazine monomer represented by Formula 4 (R₂=a phenyl group) (Yield: 96%).

### EXAMPLE 1

### Preparation of Fuel Cell

An electrode for a fuel cell was prepared according to the following process.

1 g of PtCo, 0.5 g of 5 wt % polyvinylidenefluoride solution and 4 g of NMP were mixed and the viscosity of the mixture was adjusted for coating on a substrate to prepare a cathode slurry.

The cathode slurry was coated on a carbon paper on which a microporous layer is coated using a bar coater, and the resultant was dried while the temperature was increased from room temperature to 150° C. step by step to prepare a cathode. The loading amount of PtCo in the cathode was in the range of 2.0 to 3.0 mg/cm².

1 g of Pt, 0.5 g of 5 wt % polyvinylidenefluoride solution and 1 g of NMP were mixed and the viscosity of the mixture was adjusted for coating on a substrate to prepare an anode slurry.

The anode slurry was coated on a carbon paper on which a microporous layer is coated using a bar coater, and the resultant was dried while the temperature was increased from room temperature to 150° C. step by step to prepare an anode. The loading amount of Pt in the cathode was in the range of 1.2 to 1.3 mg/cm².

6 parts by weight of BOA prepared in Synthesis Example 1, 0.3 parts by weight of HFA prepared in Synthesis Example 2 and 3.7 parts by weight of PBI were blended, and the mixture was heated to 220° C. in a heating rate of 20° C./Hr and cured to prepare a crosslinked product of polybenzoxazine-based compound.

The crosslinked product of polybenzoxazine-based compound was impregnated in a mixture of 99.5 parts by weight of 85 wt % phosphoric acid solution in water and 0.5 parts by weight a perfluorooctanesulfonic acid potassium salt at 80° C. for 12 hours to form an electrolyte membrane. Here, the amount of the phosphoric acid was about 500 parts by weight based on 100 parts by weight of the electrolyte membrane. The amount of impregnated phosphoric acid per unit area was 10 to 12 mg/cm².

A fuel cell was prepared using the cathode, anode and electrolyte membrane.

The electrode area of the fuel cell was 7.84 cm², and the fuel cell was operated at 150° C. while air was supplied into the cathode at 250 ml/min and hydrogen was supplied into the anode at 100 ml/min.

### EXAMPLE 2

### Preparation of Fuel Cell

A fuel cell was prepared and operated in the same manner as in Example 1 except that a mixture of 99.95 parts by weight of the phosphoric acid and 0.05 parts by weight of the perfluorooctanesulfonic acid potassium salt was used instead of a mixture of 99.5 parts by weight of the phosphoric acid and 0.5 parts by weight of the perfluorooctane sulfonic acid potassium salt to form an electrolyte membrane, and the amount of the PtCo loading of the cathode was 3.0 mg/cm².

### COMPARATIVE EXAMPLES 1

### Preparation of Fuel Cell

A fuel cell was prepared and operated in the same manner as Example 1, except that phosphoric acid was used instead of the mixture of 99.5 parts by weight of the phosphoric acid and 0.5 parts by weight of the perfluorooctane sulfonic acid potassium salt (CF₃(CF₂)₇SO₃K) to form an electrolyte membrane, and the amount of the PtCo loading of the cathode was 2.4 mg/cm².

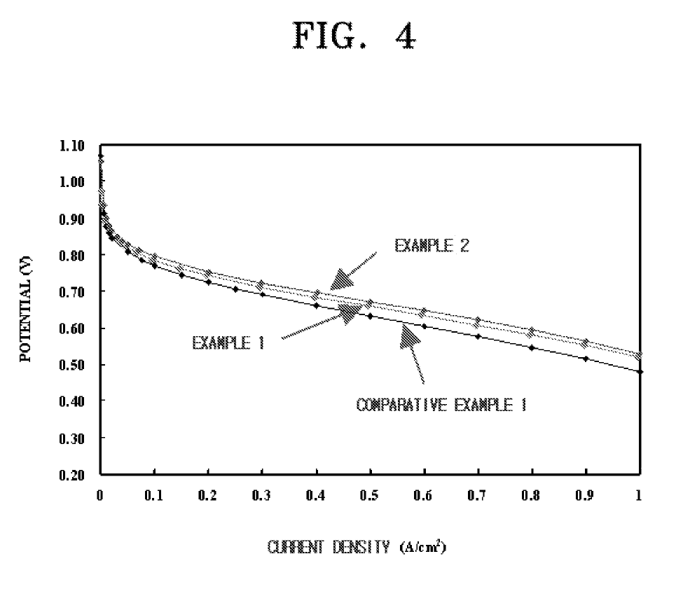

The potentials of the fuel cells prepared in Examples 1 to 2 and Comparative Example 1 according to current densities were measured, and the results are shown in FIG. 4.

Referring to FIG. 4, when the current density was 0.3 A/cm², the potential of the fuel cell of Example 1 was 0.712 V, the potential of the fuel cell of Example 2 was 0.722 V, and the potential of the fuel cell of Comparative Example 1 was 0.68 to 0.7 V. As a result, the potential was increased by using the perfluorooctane sulfonic acid potassium salt.

When the C8-C20 perfluoroalkylsulfonic acid salt is used in the preparation of the electrode and electrolyte membrane for a fuel cell according to the present invention, oxygen solubility is increased in a phosphoric acid-based material and oxygen concentration is increased in a phosphoric acid-based material of the electrode. Thus, the reactivity of oxygen reduction which is performed in a cathode is increased. The increased concentration of oxygen in the electrode increases the oxygen permeability in the cathode, and thus the resistance against reactants' transfer is decreased. As a result, the cell voltages can be increased using the electrode and the electrolyte membrane, and fuel cells having improved efficiency can be prepared.

According to the Examples described above, various electrodes and electrolyte membranes for fuel cells and fuel cells employing them can be prepared. While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A proton conductor for a fuel cell, comprising:
a phosphoric acid-based material; and
a C8-C20 perfluoroalkylsulfonic acid salt which is dissolved in the phosphoric acid-based material and has good oxygen solubility.

2. The proton conductor of claim 1, wherein the C8-C20 perfluoroalkylsulfonic acid salt is at least one of perfluorooctanesulfonic acid potassium (CF₃(CF₂)₇SO₃K) and perfluorodecanesulfonic acid potassium (CF₃(CF₂)₉SO₃K).

3. The proton conductor of claim 1, wherein the amount of the C8-C20 perfluoroalkylsulfonic acid salt is from 0.005 to 0.5 parts by weight based on 100 parts by weight of the proton conductor.

4. The proton conductor of claim 1, wherein the phosphoric acid-based material is phosphoric acid or C1-C20 organic phosphonic acid.

5. An electrode for a fuel cell, the electrode comprising a catalyst layer which includes:
a proton conductor for a fuel cell, comprising: a phosphoric acid-based material; and a C8-C20 perfluoroalkylsulfonic acid salt which is dissolved in the phosphoric acid-based material and has good oxygen solubility;
a catalyst; and
a binder.

6. The electrode of claim 5, wherein the C8-C20 perfluoroalkylsulfonic acid salt is at least one of perfluorooctanesulfonic acid potassium (CF₃(CF₂)₇SO₃K) and perfluorodecanesulfonic acid potassium (CF₃(CF₂)₉SO₃K).

7. The electrode of claim 5, wherein the amount of the C8-C20 perfluoroalkylsulfonic acid salt is from 0.005 to 0.5 parts by weight based on 100 parts by weight of the proton conductor.

8. The electrode of claim 5, wherein the phosphoric acid-based material is phosphoric acid or C1-C20 organic phosphonic acid.

9. The electrode of claim 5, wherein the catalyst is a catalyst metal which is at least one selected from the group consisting of Pt, PtCo, PtRu, PtFe and PtNi, or a supported catalyst in which the catalyst metal is loaded on a carbonaceous support.

10. The electrode of claim 5, wherein the binder is at least one selected from the group consisting of poly(vinylidene fluoride), polytetrafluoroethylene (PTFE), a tetrafluoroethylene-hexafuoroethylene copolymer, fluorinated ethylene propylene (FEP), polyurethane and styrene butadiene rubber (SBR).

11. The electrode of claim 5, wherein the amount of the proton conductor is from 0.01 to 20 parts by weight based on 1 part by weight of the catalyst.

12. An electrolyte membrane for a fuel cell, comprising:
a proton conductor including a phosphoric acid-based material and a C8-C20 perfluoroalkylsulfonic acid salt which is dissolved in the phosphoric acid-based material and has good oxygen solubility; and
a proton conductive polymer.

13. The electrolyte membrane of claim 12, wherein the phosphoric acid-based material is phosphoric acid or a C1-C20 organic phosphonic acid.

14. The electrolyte membrane of claim 12, wherein the amount of the phosphoric acid-based material is from 100 to 2000 parts by weight based on 100 parts by weight of the proton conductive polymer.

15. The electrolyte membrane of claim 12, wherein the amount of the C8-C20 perfluoroalkylsulfonic acid salt is from 0.005 to 10 parts by weight based on 100 parts by weight of the proton conductive polymer.

16. A fuel cell comprising a pair of electrodes and an electrolyte membrane interposed between the electrodes,
wherein at leas one of the electrodes and the electrolyte membrane comprises a proton conductor which includes: a phosphoric acid-based material; and a C8-C20 perfluoroalkylsulfonic acid salt which is dissolved in the phosphoric acid-based material and has good oxygen solubility.

17. The fuel cell of claim 16, wherein the C8-C20 perfluoroalkylsulfonic acid salt is at least one of perfluorooctane sulfonic acid potassium (CF₃(CF₂)₇SO₃K) and perfluorodecane sulfonic acid potassium (CF₃(CF₂)₉SO₃K).

18. The fuel cell of claim 16, wherein the amount of the C8-C20 perfluoroalkylsulfonic acid salt is from 0.005 to 0.5 parts by weight based on 100 parts by weight of the proton conductor.
